(19) United States
(12) Patent Application Publication
(10) Pub. No.: US 2015/0052198 A1
(43) Pub. Date: Feb. 19, 2015

(54) DYNAMIC SOCIAL NETWORKING SERVICE SYSTEM AND RESPECTIVE METHODS IN COLLECTING AND DISSEMINATING SPECIALIZED AND INTERDISCIPLINARY KNOWLEDGE

(71) Applicant: Joonsuh KWUN, McLean, VA (US)

(72) Inventor: Joonsuh KWUN, McLean, VA (US)

(21) Appl. No.: 13/969,274

(22) Filed: Aug. 16, 2013

(51) Int. Cl. G06F 15/173; G06F 17/30

(52) U.S. Cl. CPC G06F 15/17306; G06F 17/30286
USPC 709/204

(57) ABSTRACT

The present invention relates generally to a dynamic social network system (SNS network), specializing in the consolidation of all specialized fields of expertise into a single database network and rendering the maximized ability to collect and disseminate specialized and interdisciplinary fields of knowledge from academic events. The present invention acts as a platform in which public and private institutions could utilize in advertising their academic events to the people interested in or concerned with the topic/content but unaware of certain academic events.

### BACKGROUND OF THE INVENTION

1. Field of the Invention

The present invention relates generally to a social network system (SNS network) and more particularly to a database network system and methods for collecting and disseminating specialized and interdisciplinary knowledge.

2. Description of Related Art

Conventionally, individuals who wish to attend an academic event had to manually visit the website of the hosts to find more information such as the topic and description of the event, location, time, etc. Also, these academic events are restricted to the ones that are aware of them. In a sense the knowledge to be collected and disseminated are restricted. There is therefore, a need for systems and methods for a dynamic social networking service system and respective methods in collecting and disseminating specialized and interdisciplinary knowledge.

### BRIEF DESCRIPTION OF THE DRAWINGS

FIG. 1 illustrates an exemplary environment for a dynamic social networking service system and respective methods in collecting and disseminating specialized and interdisciplinary knowledge in accordance with an embodiment of the invention;

FIG 2 is a block diagram of a database in accordance with an embodiment of the invention;

FIG. 3 is a flow diagram of an exemplary process for maximizing the advertisement of academic events in accordance with an embodiment of the invention;

FIG. 4 is a flow diagram of an exemplary process for forming an attendee network in accordance with an embodiment of the invention;

FIG. 5 is a flow diagram of an exemplary process for allowing a direct communication between the attendees and hosts in accordance with an embodiment of the invention.

### DETAILED DESCRIPTION OF THE INVENTION

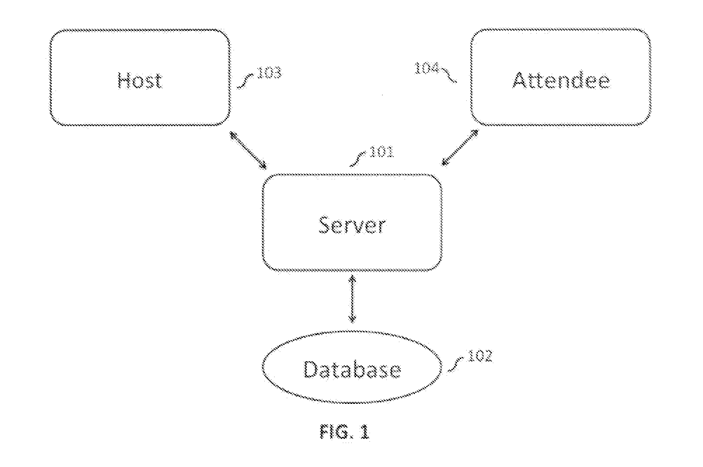

FIG. 1 illustrates an exemplary environment for a dynamic social networking service system and respective methods in collecting and disseminating specialized and interdisciplinary knowledge. One or more members, such as an attendee 103 or a host 104 at a member device are coupled to each other along with a database 102 via a central server 101.

In this way, a dynamic social network system (SNS network), specializing in the consolidation of all academic fields into a single database network and rendering the maximized ability to collect and disseminate knowledge in specialized and interdisciplinary fields, was created.

In addition, this social network serves as a platform that the public and private institutions could utilize in advertising their academic events such as but not limited to seminars, round tables, and forums. On this platform, discussions/forums are facilitated for the individuals, companies, or organizations in specialized and interdisciplinary fields to cooperate, discuss, further examine, analyze, synthesize, and advance ideas/technology. Furthermore, the members could use this social network to commuuicate and network in order to build healthy business and personal relationships.

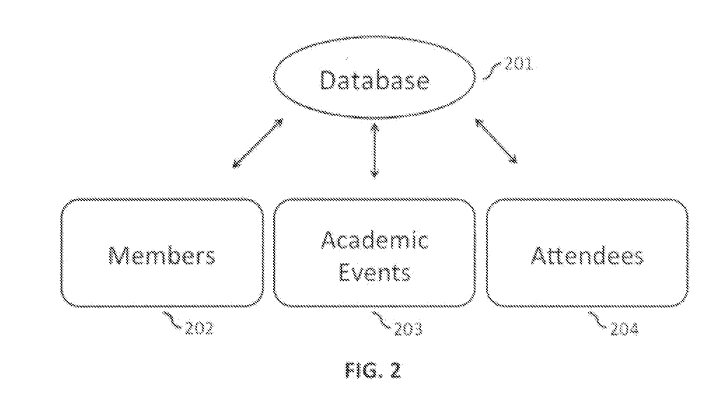

FIG. 2 refers to the specific constituents of the database 201 comprising of members database, academic events database, and attendees database.

The members database 202 hosts the data of the members of the website submitted through the server on the registration page such as but not limited to the member's name, location, and academic field of interest/specialty. Further, the attendees and hosts constitute the members database and the terminology “member” is to be used interchangeably with attendees and hosts.

The academic events database 203 hosts the data of academic events to be hosted by public and private institutions submitted through the server on the submission page such as but not limited to the academic events' name, topic, time, location, description, fee, and a promotional video. The academic events such as seminars, forums, round tables, workshops etc., are categorized and classified by the topics and subjects.

The attendee database 204 hosts the data of the attendees of academic events submitted through the server by clicking a button such as but not limited to the attendee's name, location, and academic field of interest/specialty. Due to the much-shared data, the attendees database serves as a subset of members database. However, a clear distinction exists in the functionality of the attendees database since it is primarily used for forming an attendee network in order to facilitate easy and direct communication between the attendees and the hosts.

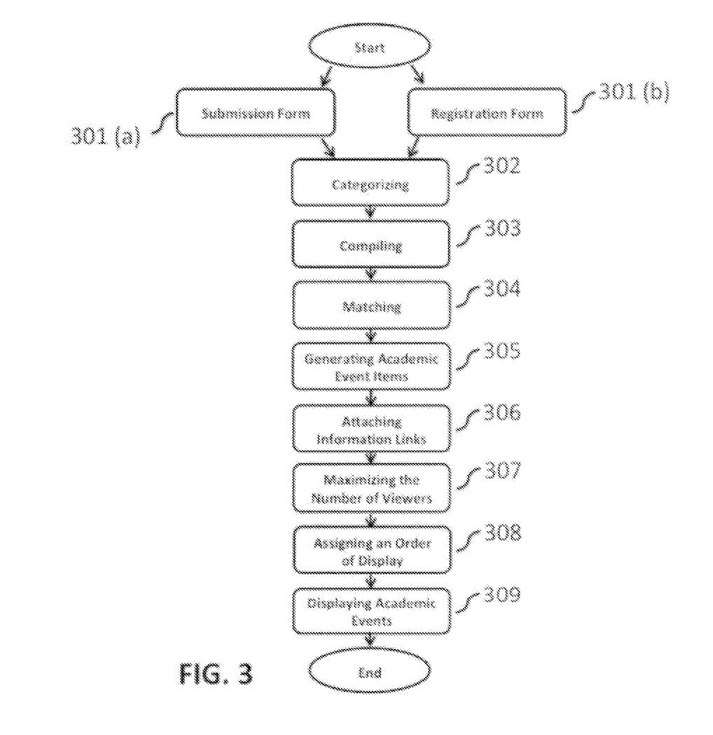

Referring now to FIG. 3, a flow diagram of an exemplary process for maximizing the advertisement of academic events is shown.

At step 301 (a), the information of the hosts submitted through the server on the submission form is stored in the academic events database 203 and at step 301 (b), the information of the attendees submitted through the server on the registration form is stored in the members database 202 as well.

Then once the information has been entered into the database, at step 302, the information is categorized by the academic fields and compiled 303. Then the topics of the academic events as submitted by the hosts are matched 304 with the fields of interest/specialty of the members. Then the academic event items are generated 305 by the academic events database along with the attachment of informational links 306 that includes the name, topic, time, location, description, fee, and a promotional video.

At step 307, notifications are sent to all of the members that have an interest/specialty in a certain academic field, thus maximizing the advertisement of the event. For example, if a chemical company is hosting an academic event, notifications are sent to all of the users who entered information into the members database 202 stating that they are interested or hold expertise in fields related to chemistry.

At step 308 an order of display is assigned with regards to the personal preference of the members. The members have three options of display: assigning an order of display by distance/location, time, or the relevance to the member's interest or specialized fields. Finally, the academic events are displayed 309.

Through this method, the present system provides more open academic events to the individuals, companies, or organizations that have interest or concern in the topic/content of the academic events compared to the restrictive conventional system in which only those aware of the academic events can participate.

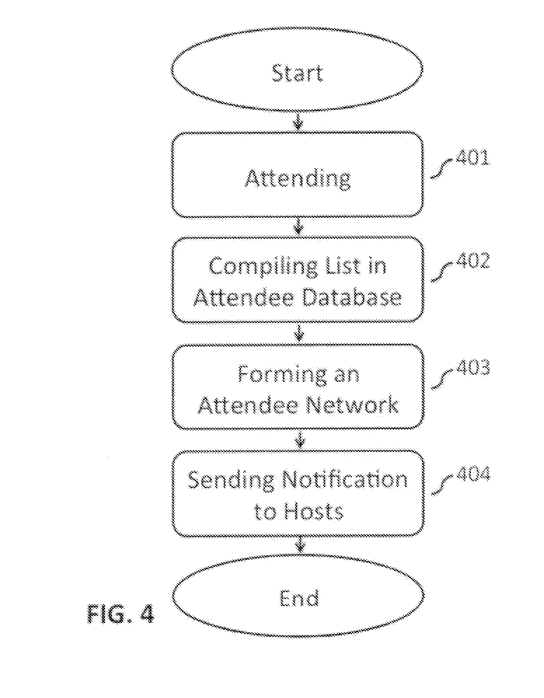

Referring now to FIG. 4, a flow diagram of an exemplary process for forming an attendee network is shown.

At step 401, once the members click a button displayed on an academic event, their information is compiled into a list in the attendees database 402. Thus, at step 403, an attendee network is formed, and at step 404, the list of attendees is sent to the hosts through the central server 101.

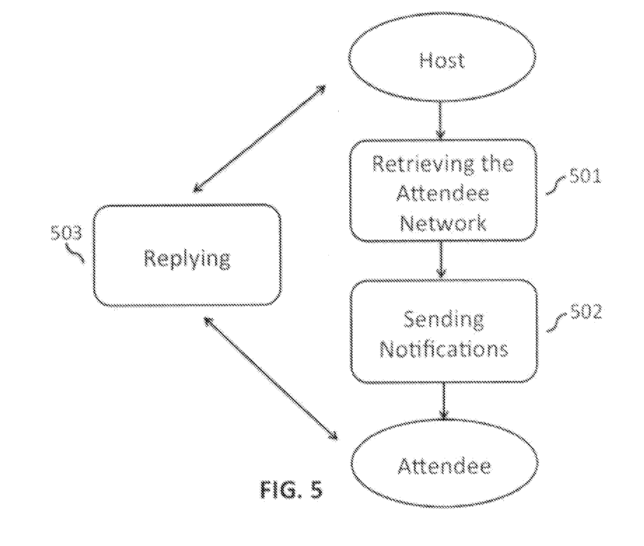

FIG. 5 displays a flow diagram of an exemplary process for facilitating direct communication between attendees and hosts.

At step 501, the attendee network is retrieved from the attendees database 204. At step 502, the hosts 103 send messages in the form of notifications to the attendees 104 throngh the central server 101. The attendees who received notifications could directly reply 503 to the hosts with questions or comments.

Through these methods, an attendee network could be utilized in facilitating direct communications between the attendees and hosts in order to better the academic events as well as advance fields of interest through the sharing and collecting of knowledge.

In conclusion, a dynamic social networking service system in collecting and disseminating specialized and interdisciplinary knowledge and respective methods in maximizing the advertisement of academic events was created.

It is to be understood that these detailed descriptions and embodiments illustrated should not be considered in a limiting sense since they are only exemplary and explanatory and are not restrictive of the invention, as claimed.

What is claimed is:

1. A dynamic social network system (SNS), specializing in the consolidation of all academic fields into a single database network and rendering the maximized ability to collect and disseminate knowledge in specialized and interdisciplinary fields, comprising:
a central server that facilitates the holistic interactions between attendees, hosts, and the database;
attendees that are a subset of members and participate in academic events of their interests;
hosts that are a subset of members and arranges the academic events; and
a database that holds information of members and academic events.

2. The dynamic social network system of claim 1, wherein the server receives the information submitted by the members—attendees and hosts—and encodes them into the database.

3. The dynamic social network system of claim 1, wherein the server acts as a platform that public and private institutions utilize in sending notifications from hosts to the members to advertise their academic events such as but not limited to seminars, round tables, and forums.

4. The dynamic social network system of claim 1, wherein the server facilitates the individuals, companies, or organizations to communicate and network with one another.

5. The dynamic social network system of claim 1, wherein the database is further constituted by members, academic events, and attendees database.

6. A method for the hosts to maximize the advertisement of their academic events in order to attract a greatest number of people, comprising:
receiving, by the server via a registration/submission page, personal/business information sent by a first user on a member device, attendee and host, on a first computer of a plurality of computers communicating via a network;
categorizing the information submitted by the member devices, attendee and host, through the database server and compiling the information of the member devices into a members database;
matching the information of the member devices: attendees, submitted through a registration form, with the information of the hosts, submitted through a submission form, such as their interested academic or specialized fields;
generating a plurality of academic event items from the academic events database that relate to the interested academic or specialized fields of the member devices;
attaching information links associated with the academic events;
maximizing the number of viewers of the academic events by sending notifications to a set of respective member devices interested or specialized in the academic fields;
assigning an order of displaying the academic events to fit the preference of the member devices; and
displaying the academic events to all the viewing member devices of the predetermined set of viewing member devices.

7. The method of claim 6, wherein the information received by the members database further comprises at least one of the following: member's name, academic fields of interest/specialty, location.

8. The method of claim 6, wherein the plurality of academic events from the academic events database is selected according to an affinity determined for the viewing member device.

9. The method of claim 6, wherein the generating includes:
monitoring an interaction of the viewing user with at least one of the plurality of academic events items; and
utilizing the interaction to generate additional academic events.

10. The method of claim 6, wherein the generating includes searching and generating the one or more academic events for a predetermined character string such as the field of interest/specialty of a member as inserted into the members database.

11. The method of claim 6, wherein the informational links comprise of time, location, fee, description, promotional video, and a button of an academic event.

12. The method of claim 6, wherein an order is assigned accordingly to the personal preference of the members: chronological order of occurrence, proximity of the location, or relevance of the academic events to the member device's interested academic fields or expertise.

13. A method for forming an attendee network of an academic event, the method comprising:
clicking a button for a certain academic event;
compiling, through the server, a list of attendees into an attendees database; and
forming an attendee network and sending the selected network in a form of a notification to the hosts of an academic event.

14. The method of claim 13, wherein the related information received by the attendees database further comprises at least one of the following: attendee's name, fields of interest/specialty, and location.

15. A method for the attendees and the hosts of an academic event to directly communicate with each other, by selecting and calling upon the attendee network formed in the attendees database, the hosts send messages to the members via the central server, vice versa.
